(19) United States
(12) Patent Application Publication
(10) Pub. No.: US 2025/0358302 A1
(43) Pub. Date: Nov. 20, 2025

(54) DEVICE AND METHOD FOR PERFORMING TASK FOR CYBERSECURITY BASED ON DARK WEB

(71) Applicants: S2W INC., Seongnam-si (KR); Korea Advanced Institute of Science and Technology, Daejeon (KR)

(72) Inventors: Eu Gene JANG, Seongnam-si (KR); Jin Woo CHUNG, Seongnam-si (KR); Yong Jae LEE, Seongnam-si (KR); Young Jin JIN, Daejeon (KR); Jian CUI, Bloomington, IN (US); Seung Won SHIN, Daejeon (KR); Chang Hoon YOON, Seongnam-si (KR); Sang Duk SUH, Seongnam-si (KR); Keun Tae PARK, Seoul (KR)

(73) Assignees: S2W INC., Seongnam-si (KR); Korea Advanced Institute of Science and Technology, Daejeon (KR)

(21) Appl. No.: 19/210,538

(22) Filed: May 16, 2025

(30) Foreign Application Priority Data
May 17, 2024 (KR) 10-2024-0064347

(51) Int. Cl. H04L 9/40; G06N 3/045; G06N 3/09

(52) U.S. Cl. CPC H04L 63/1425; G06N 3/045; G06N 3/09; H04L 63/1441

(57) ABSTRACT

Provided are a device and method for performing a task for cybersecurity on the basis of a dark web. The method performed by a device includes acquiring raw dark web data from a database, acquiring first dark web data by preprocessing the raw dark web data, pretraining a bidirectional encoder representations from transformers (BERT)-based language model using the first dark web data, fine-tuning the pretrained BERT-based language model using second dark web data, and performing a task for cybersecurity using the fine-tuned BERT-based language model.

### CROSS-REFERENCE TO RELATED APPLICATION

This application claims priority to and the benefit of Korean Patent Application No. 2024-0064347, filed on May 17, 2024, the disclosure of which is incorporated herein by reference in its entirety.

### BACKGROUND

### 1. Field of the Invention

The following embodiments relate to a device and method for performing a task for cybersecurity on the basis of the dark web. More particularly, the following embodiments relate to a device and method for performing various tasks for cybersecurity in the dark web which is a special web based on the Tor network.

### 2. Discussion of Related Art

The surface web, also known as the visible web, refers to the indexable portion of the Internet. In other words, content of this part of the World Wide Web (WWW) is easily accessible and searchable using search engines. The surface web makes up about 5% of the Internet's information.

On the other hand, the deep web refers to the non-indexable parts of the Internet, that is, content that is only accessible using encryption or specific software. The deep web makes up more than 90% of the Internet's information.

In the deep web, the dark web refers to websites in the dark net, a collective name for a variety of websites and marketplaces where individuals looking to engage in illegal or shady activities congregate. The dark web is inaccessible using existing browsers and is not indexed by general search engines. The dark web has become notorious for stories of large-scale illegal activity, but has various legitimate uses such as secure communication, whistleblowing, censorship circumvention, and the like.

Recent studies have shown that there is a clear difference between the language used on the dark web and the language used on the surface web.

### SUMMARY OF THE INVENTION

The present disclosure is directed to providing a device and method for performing a task for cybersecurity on the basis of the dark web.

Objects to be achieved by the present disclosure are not limited to that described above, and other objects which have not been described will be clearly understood by those skilled in the technical field to which the present disclosure pertains from the present specification and accompanying drawings.

According to an aspect of the present disclosure, there is provided a method of performing a task for cybersecurity on the basis of the dark web that is performed by a device, the method including acquiring raw dark web data from a database, acquiring first dark web data by preprocessing the raw dark web data, pretraining a bidirectional encoder representations from transformers (BERT)-based language model using the first dark web data, fine-tuning the pretrained BERT-based language model using second dark web data, and performing a task for cybersecurity using the fine-tuned BERT-based language model.

The acquiring of the first dark web data by preprocessing the raw dark web data may include acquiring a dark web text dataset from the raw dark web data, balancing the dark web text dataset on the basis of categories, and removing duplicate data of the dark web text dataset using a text similarity algorithm.

When the task is ransomware leak site detection, the fine-tuning of the pretrained BERT-based language model using the second dark web data may include collecting ransomware leak sites from the raw dark web data, labeling the ransomware leak sites as the second dark web data, and training the BERT-based language model using the second dark web data.

When the task is threat thread classification, the fine-tuning of the pretrained BERT-based language model using the second dark web data may include collecting threat threads from the raw dark web data, labeling the threat threads as the second dark web data, and training the BERT-based language model using the second dark web data.

The method may further include, when the task is threat keyword inference, masking one or more elements in the raw dark web data, and the performing of the task for cybersecurity using the fine-tuned BERT-based language model may include outputting a possibility value of at least one element corresponding to a masked position using the fine-tuned BERT-based language model.

The raw dark web data may include nonlinguistic elements, and some of the nonlinguistic elements from which linguistic meaning is inferable may be included among targets of masking.

According to another aspect of the present disclosure, there is provided a device for performing a task for cybersecurity on the basis of the dark web, the device including a memory and at least one processor including a BERT-based language model. The processor acquires raw dark web data from a database, acquires first dark web data by preprocessing the raw dark web data, pretrains the BERT-based language model using the first dark web data, fine-tunes the pretrained BERT-based language model using second dark web data, and performs a task for cybersecurity using the fine-tuned BERT-based language model.

According to another aspect of the present disclosure, there is provided a non-transitory computer-readable recording medium on which a computer program executed by a computer which is hardware is recorded, the computer program including acquiring raw dark web data from a database, acquiring first dark web data by preprocessing the raw dark web data, pretraining a BERT-based language model using the first dark web data, fine-tuning the pretrained BERT-based language model using second dark web data, and performing a task for cybersecurity using the fine-tuned BERT-based language model.

Solutions to the objects of the present disclosure are not limited to those described above, and other solutions which have not been described will be clearly understood by those skilled in the technical field to which the present invention pertains from the present specification and accompanying drawings.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a conceptual diagram illustrating a method of performing a task for cybersecurity on the basis of the dark web according to an exemplary embodiment of the present disclosure;

FIG. 2 is a block diagram of a system for performing a task for cybersecurity on the basis of the dark web according to an exemplary embodiment of the present disclosure;

FIG. 3 is a flowchart of a method of performing a task for cybersecurity on the basis of the dark web according to an exemplary embodiment of the present disclosure;

FIG. 4 is a set of circle charts before and after dark web text datasets are balanced according to an exemplary embodiment of the present disclosure;

FIG. 5 shows a screen corresponding to a threat thread and a screen corresponding to non-threat thread according to an exemplary embodiment of the present disclosure;

FIG. 6 shows an example of threat keyword inference and a table showing performance of a bidirectional encoder representations from transformers (BERT)-based language model that infers a threat keyword according to an exemplary embodiment of the present disclosure;

FIGS. 7A and 7B are configuration diagrams illustrating a system for training a language model for cybersecurity according to an exemplary embodiment of the present disclosure; and

FIGS. 8 to 13 are exemplary diagrams illustrating a process of training a language model for cybersecurity according to an exemplary embodiment of the present disclosure.

### DETAILED DESCRIPTION OF EXEMPLARY EMBODIMENTS

Specific structural or functional descriptions merely exemplify embodiments according to the concept of the present disclosure disclosed in the present specification, and embodiments according to the concept of the present disclosure may be implemented in various forms and are not limited to the embodiments described herein.

Since the embodiments according to the concept of the present disclosure are subject to various modifications and may take a variety of forms, embodiments are illustrated in the drawings and described in detail in the present specification. However, this is not intended to limit the embodiments according to the concept of the present disclosure to any disclosed form, and is to be understood to include all modifications, equivalents, or substitutions that fall within the spirit and technical scope of the present disclosure.

Terms such as “first,” “second,” and the like may be used to describe various components, but the components are not limited by the terms. The above terms are used solely for the purpose of distinguishing one component from another. For example, a first component may be named a second component, and similarly a second component may be named a first component, without departing from the scope of rights according to the concept of the present disclosure.

When a component is referred to as “coupled” or “connected” to another component, it should be understood that the component may be directly coupled or connected to the other component or there may be still another component therebetween. On the other hand, when a component is referred to as “directly coupled” or “directly connected” to another component, it should be understood that there is no other component therebetween. Other expressions describing the relationship between components, such as “between” and “directly between,” “adjacent to” and “directly adjacent to,” and the like, should be construed similarly.

Terminology used herein is intended to describe particular embodiments only and is not intended to limit the present disclosure. Singular expressions include plural expressions unless context clearly indicates otherwise. As used herein, terms such as “include,” “have,” and the like are intended to designate the presence of described features, numbers, steps, operations, components, parts, or combinations thereof, and are not intended to preclude the presence or addition of one or more other features, numbers, steps, operations, components, parts, or combinations thereof.

Unless otherwise defined, all terms used herein, including technical or scientific terms, have the same meaning as commonly understood by those of ordinary skill in the technical field to which the present disclosure pertains. Terms such as those defined in commonly used dictionaries should be construed as having meanings consistent with their meaning in the context of the relevant art and should not be construed as having an idealized or unduly formal meaning unless expressly defined in the present specification.

In the present specification, a processor may be hardware that may perform a function and operation in accordance with each name described herein, computer program code that may perform a specific function and operation, or an electronic recording medium on which computer program code for performing a specific function and operation is recorded.

In other words, a processor may be a functional and/or structural combination of hardware for realizing the technical spirit of the present disclosure and/or software for driving the hardware.

Hereinafter, exemplary embodiments of the present disclosure will be described in detail with reference to the accompanying drawings. However, the scope of the present application is not limited to the embodiments. Throughout the drawings, like reference numerals refer to like components.

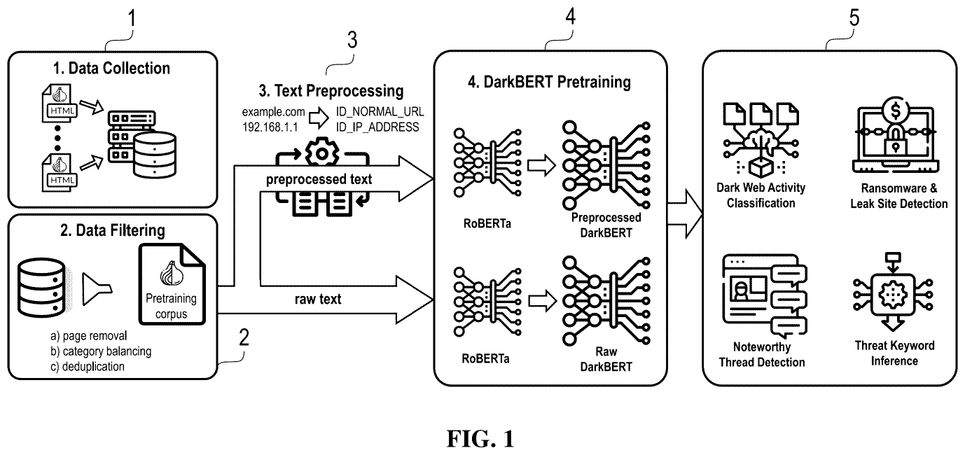

FIG. 1 is a conceptual diagram illustrating a method of performing a task for cybersecurity on the basis of the dark web according to an exemplary embodiment of the present disclosure.

Referring to FIG. 1, a method of performing a task for cybersecurity on the basis of the dark web according to an exemplary embodiment of the present disclosure may include a data collection operation 1, a data filtering operation 2, a text preprocessing operation 3, a DarkBERT pretraining operation 4, and/or an evaluation operation 5. Here, according to the exemplary embodiment, a DarkBERT is a bidirectional encoder representations from transformers (BERT)-based language model.

A device for performing a task for cybersecurity on the basis of the dark web according to an exemplary embodiment of the present disclosure may collect data (1). Here, the data may be raw dark web data.

The device for performing a task for cybersecurity on the basis of the dark web according to the exemplary embodiment of the present disclosure may filter the raw dark web data (2). Also, the device for performing a task for cybersecurity on the basis of the dark web according to the exemplary embodiment of the present disclosure may preprocess text (3). Here, the operation 2 of filtering the raw dark web data and the operation 3 of preprocessing the text may correspond to a data preprocessing process. Through the data preprocessing process, data for pretraining (hereinafter “first dark web data”) may be selected from the raw dark web data.

The device for performing a task for cybersecurity on the basis of the dark web according to the exemplary embodiment of the present disclosure may pretrain the DarkBERT. The pretrained DarkBERT may perform a task for cybersecurity on the basis of the dark web. In accordance with the task, the pretrained DarkBERT may be fine-tuned using some labeled data of the raw dark web data (hereinafter “second dark web data”).

The device for performing a task for cybersecurity on the basis of the dark web according to the exemplary embodiment of the present disclosure may evaluate the DarkBERT (5).

According to embodiments, the BERT-based language model may be pretrained using the preprocessed data for pretraining related to the dark web and then fine-tuned using labeled data. In this way, the BERT-based language model can learn context specialized for the dark web, and the performance of the BERT-based language model can be improved accordingly.

According to embodiments, it is possible to perform tasks for cybersecurity, such as detecting a ransomware leak site, detecting a threat thread, inferring a threat keyword, and the like, using a high-performance language model specialized for the dark web where a cybercrime ecosystem is formed and various illegal activities are conducted.

A type of cybercrime committed in the dark web is the sale or publication of personal and confidential data of an institution leaked by a ransomware group. This may occur in the form of a leak site (i.e., a ransomware leak site) that exposes the victim and threatens the victim with disclosure of the victim's sensitive data (e.g., financial information, personal assets, and personal identification information).

Here, the threat thread may be a noteworthy thread in terms of cybersecurity that poses some level of threat to cybersecurity. For example, the threat thread may be text posted on hacking forums that exist in various forms on the dark web or the post(s). Dark web forums are often used for illegal information exchange, and vast amounts of new forum posts appear. Accordingly, manually reviewing each thread requires significant human resources.

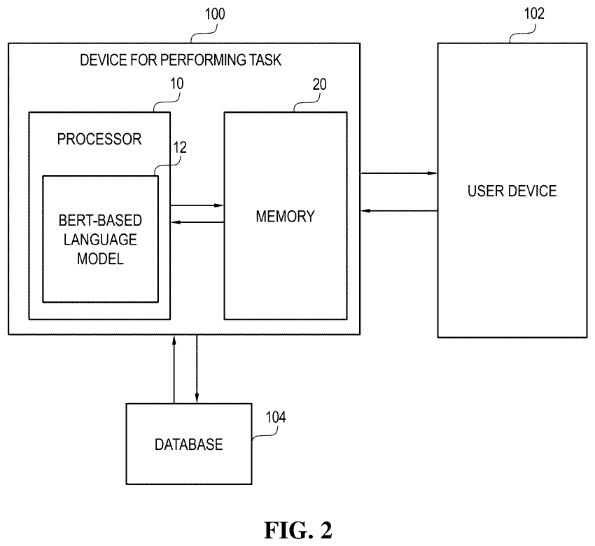

FIG. 2 is a block diagram of a system for performing a task for cybersecurity on the basis of the dark web according to an exemplary embodiment of the present disclosure.

The system for performing a task for cybersecurity on the basis of the dark web may include a device 100 for performing a task for cybersecurity on the basis of the dark web, a user device 102, and/or a database 104.

The device 100 for performing a task for cybersecurity on the basis of the dark web includes a processor 10 and/or a memory 20. The device 100 for performing a task for cybersecurity on the basis of the dark web may further include a transceiver (not shown) and/or an interface (not shown).

In the device 100 for performing a task for cybersecurity on the basis of the dark web, the processor 10 may include a BERT-based language model 12. The BERT-based language model 12 according to the exemplary embodiment of the present disclosure may be a model that is previously trained using data for pretraining related to the dark web. In addition, the BERT-based language model 12 according to the exemplary embodiment of the present disclosure may be the previously trained model that is fine-tuned using labeled data.

The processor 10 may process data stored in the memory 20. The processor 10 may execute computer-readable code (e.g., software) stored in the memory 20 and instructions generated by the processor 10.

The processor 10 may be a data processing device that is implemented as hardware with circuitry having a physical structure to execute desired operations. For example, the desired operations may include code or instructions included in a program.

For example, the data processing device implemented as hardware may include a microprocessor, a central processing unit (CPU), a processor core, a multi-core processor, a multiprocessor, an application-specific integrated circuit (ASIC), and a field programmable gate array (FPGA).

The memory 20 may store data required for the device 100 for performing a task for cybersecurity on the basis of the dark web to operate. The memory 20 may be implemented as a volatile memory device and/or a non-volatile memory device.

The volatile memory device may be implemented as a dynamic random access memory (DRAM), a static random access memory (SRAM), a thyristor RAM (T-RAM), a zero capacitor RAM (Z-RAM), or a twin transistor RAM (TTRAM).

The non-volatile memory device may be implemented as an electrically erasable programmable read-only memory (EEPROM), a flash memory, a magnetic RAM (MRAM), a spin-transfer torque (STT)-MRAM, a conductive bridging RAM (CBRAM), a ferroelectric RAM (FeRAM), a phase change RAM (PRAM), a resistive RAM (RRAM), a nanotube RRAM, a polymer RAM (PoRAM), a nano-floating-gate memory (NFGM), a holographic memory, a molecular electronic memory device, or an insulator resistance change memory.

According to the exemplary embodiment, in the system for performing a task for cybersecurity on the basis of the dark web, the device 100 for performing a task for cybersecurity on the basis of the dark web may acquire raw dark web data from the database 104. The raw dark web data may be pages of the dark web that the device 100 for performing a task may access using a specialized web browser (e.g., Tor) alone. Alternatively, the raw dark web data may be text included in the pages of the dark web that the device 100 for performing a task may access using the specialized web browser (e.g., Tor) alone.

The device 100 for performing a task for cybersecurity on the basis of the dark web may acquire first dark web data by preprocessing the raw dark web data.

The device 100 for performing a task for cybersecurity on the basis of the dark web may pretrain a BERT-based language model using the first dark web data.

The device 100 for performing a task for cybersecurity on the basis of the dark web may fine-tune the pretrained BERT-based language model using second dark web data.

The device 100 for performing a task for cybersecurity on the basis of the dark web may perform a task for cybersecurity using the fine-tuned BERT-based language model.

The device 100 for performing a task for cybersecurity on the basis of the dark web may be implemented as a printed circuit board (PCB), such as a motherboard, an integrated circuit (IC), or a system on chip (SoC). For example, the device 100 for performing a task for cybersecurity on the basis of the dark web may be implemented as an application processor.

Also, the device 100 for performing a task for cybersecurity on the basis of the dark web and/or the user device 102 may be implemented in a personal computer (PC), a server, or a portable device.

The portable device may be implemented as a laptop computer, a mobile phone, a smartphone, a tablet PC, a mobile internet device (MID), a personal digital assistant (PDA), an enterprise digital assistant (EDA), a digital still camera, a digital video camera, a portable multimedia player (PMP), a personal or portable navigation device (PND), a handheld game console, an e-book, or a smart device. The smart device may be implemented as a smart watch, a smart band, or a smart ring.

According to the exemplary embodiment, the method of performing a task for cybersecurity on the basis of the dark web may be performed in the form of an application or program by the user device 102. The application for performing a task for cybersecurity on the basis of the dark web may be an application program that is run on a PC or a portable device. The application for performing a task for cybersecurity on the basis of the dark web may display information processed by the device 100 for performing a task for cybersecurity on the basis of the dark web and/or the user device 102 through a display or display a user interface (UI) or a graphical user interface (GUI) in accordance with the information processed by the device 100 for performing a task for cybersecurity on the basis of the dark web and/or the user device 102 through the display. The information processed by the device 100 for performing a task for cybersecurity on the basis of the dark web may include information on the raw dark web data, the first dark web data, the second dark web data, and the like.

The database 104 may be a database that is connected by wire or wirelessly to the device 100 for performing a task for cybersecurity on the basis of the dark web. According to the exemplary embodiment, the database 104 may be a dark web database including raw dark web data, ransomware leak sites, threat threads, and the like, which is acquired by crawling the dark web and/or a model database including data for pretraining, preprocessed data, labeled data, and the like.

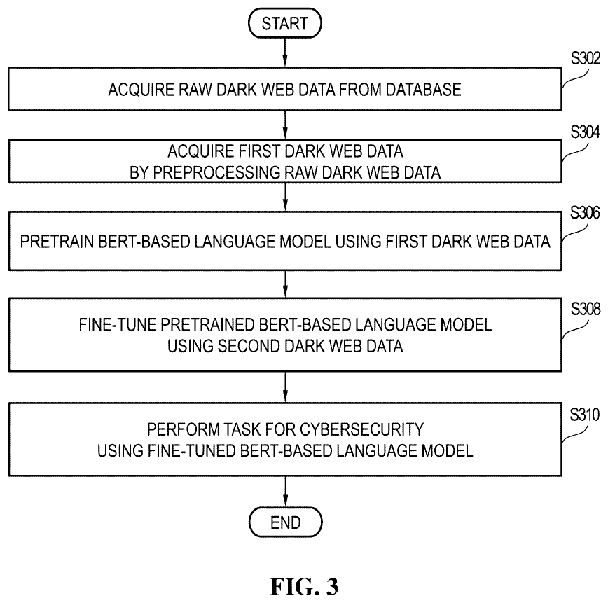

FIG. 3 is a flowchart of a method of performing a task for cybersecurity on the basis of the dark web according to an exemplary embodiment of the present disclosure.

Referring to FIG. 3, the device 100 for performing a task for cybersecurity on the basis of the dark web may acquire raw dark web data from a database (S302).

A vast text corpus composed of pages of the dark web is required for training a DarkBERT in advance. The device 100 for performing a task for cybersecurity on the basis of the dark web may extract raw dark web data by crawling the dark web. In this way, the device 100 for performing a task for cybersecurity on the basis of the dark web may build a dark webpage database. Here, the collected data (or raw dark web data) may be a considerable amount of data, but some of the data may include meaningless information such as error messages or duplicates of other webpages.

The device 100 for performing a task for cybersecurity on the basis of the dark web may acquire first dark web data by preprocessing the raw dark web data (S304).

The device 100 for performing a task for cybersecurity on the basis of the dark web may acquire a dark web text dataset from the raw dark web data as a part of a preprocessing process. Here, the dark web text dataset may be a CoDA (Comprehensive Dark web Annotations) dataset. The device 100 for performing a task for cybersecurity on the basis of the dark web may balance the dark web text dataset on the basis of categories.

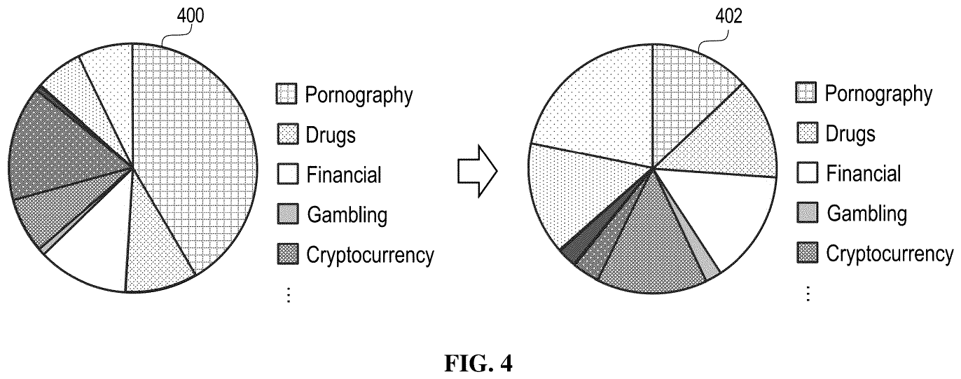

FIG. 4 shows a categorized dark web text dataset 400 before balancing and a categorized dark web text dataset 402 after balancing.

Before balancing, that is, preprocessing, the dark web text dataset 400 is dominated by data categorized as pornography. However, the dark web text dataset 400 may be balanced such that a BERT-based language model according to an embodiment of the present disclosure may understand dark web data in various categories, such as drugs, gambling, and the like, in addition to pornography, and that the BERT-based language model may perform a task for cybersecurity to be described below well. Referring to the categorized dark web text dataset 402 after balancing, data classified as pornography is reduced compared to the categorized dark web text dataset 400 before balancing.

In addition, the device 100 for performing a task for cybersecurity on the basis of the dark web may remove duplicate data of the dark web text dataset using a text similarity algorithm as a part of a preprocessing process. The text similarity algorithm may be Minhash. The device 100 for performing a task for cybersecurity on the basis of the dark web may measure the similarity between any dark web data using the text similarity algorithm. When the measured similarity is a threshold or more, at least one piece of the dark web data may be determined as duplicate data and removed.

Further, the device 100 for performing a task for cybersecurity on the basis of the dark web may perform text preprocessing as a part of a preprocessing process. For example, the device 100 for performing a task for cybersecurity on the basis of the dark web may filter out personal information and/or sensitive information from the text data included in the raw dark web data. The device 100 for performing a task for cybersecurity on the basis of the dark web may filter out noise data and/or meaningless data which is unnecessary during a pretraining process of the BERT-based language model.

Referring back to FIG. 3, the device 100 for performing a task for cybersecurity on the basis of the dark web may pretrain the BERT-based language model using the first dark web data (S306).

The device 100 for performing a task for cybersecurity on the basis of the dark web may fine-tune the pretrained BERT-based language model using second dark web data (S308).

According to an exemplary embodiment, when the task is ransomware leak site detection, the operation S308 of fine-tuning the pretrained BERT-based language model using the second dark web data may include an operation of collecting ransomware leak sites from the raw dark web data, an operation of labeling the ransomware leak sites as the second dark web data, and an operation of training the BERT-based language model using the second dark web data.

According to another exemplary embodiment, when the task is threat thread classification, the operation S308 of fine-tuning the pretrained BERT-based language model using the second dark web data may include an operation of collecting threat threads from the raw dark web data, an operation of labeling the threat threads as the second dark web data, and an operation of training the BERT-based language model using the second dark web data.

The device 100 for performing a task for cybersecurity on the basis of the dark web may perform the task for cybersecurity using the fine-tuned BERT-based language model (S310).

As an example, the device 100 for performing a task for cybersecurity on the basis of the dark web may detect a ransomware leak site using the fine-tuned BERT-based language model.

As another example, the device 100 for performing a task for cybersecurity on the basis of the dark web may categorize a threat thread using the fine-tuned BERT-based language model.

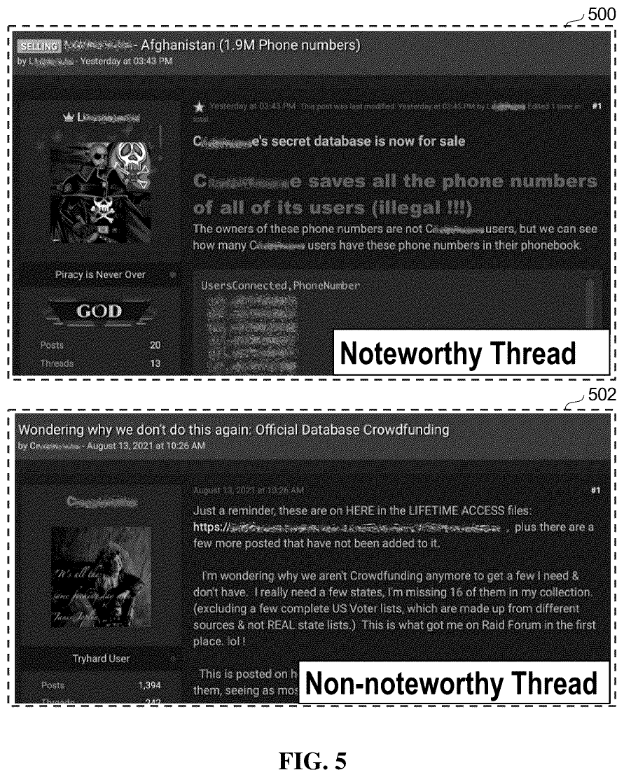

Referring to FIG. 5, the device 100 for performing a task for cybersecurity on the basis of the dark web may determine or categorize a threat thread that actually threatens cybersecurity to a certain degree, that is, a noteworthy thread, and a non-noteworthy thread. A first screen 500 shows a noteworthy thread. A second screen 502 shows a non-noteworthy thread.

The first screen 500 is a screen for illegally sharing cellular phone numbers of multiple users. In the present specification, a “noteworthy thread” may be referred to as a “threat thread.” On the other hand, the second screen 502 shows a thread that does not threaten cybersecurity.

Referring back to FIG. 3, the device 100 for performing a task for cybersecurity on the basis of the dark web may infer a threat keyword using the BERT-based language model.

The device 100 for performing a task for cybersecurity on the basis of the dark web may mask one or more elements of the raw dark web data. Here, the operation S310 of performing the task for cybersecurity using the fine-tuned BERT-based language model may include an operation of outputting a possibility value of at least one element corresponding to a masked position.

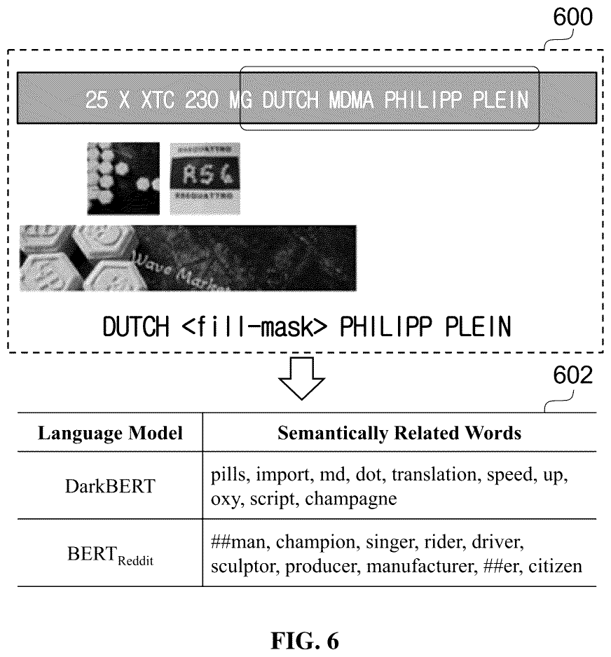

FIG. 6 shows an example of threat keyword inference and a table showing performance of a BERT-based language model that infers a threat keyword according to an exemplary embodiment of the present disclosure.

Referring to FIG. 6, an example of a sample medication sales page on the dark web is shown where a user advertises an MDMA pill with the Philipp Plein logo.

In the dark web, a variety of terms associated with pornography, drugs, gambling, and the like are used. To determine what these terms mean using a BERT-based language model according to an exemplary embodiment of the present disclosure, for example, the element “MDMA” (i.e., a threat keyword) may be masked in “DUTCH MDMA PHILIPP PLEIN.”

In a table 602 comparing prediction results of a BERT-based language modelDarkBERT according to the present disclosure and another language model BERTReddit, which predicted semantically related words in the fill-mask position, the BERT-based language model DarkBERT according to the present disclosure may propose words relatively associated with medication, such as pill and the like, as candidate words regarding which words are semantically related to the fill-mask position. On the other hand, the other language model BERT Reddit outputs words not associated with medication such as man, champion, and the like.

Here, raw dark web data includes more non-linguistic elements than other documents. The non-linguistic elements may include information that is unrelated to the structure, grammar, and meanings of context and thus not language-related or not suited to the training objective of the model.

Non-linguistic elements are complex, arbitrary, and often meaningless strings of characters, and self-supervised learning applied thereto is ineffective. When unsupervised learning is performed without considering these non-linguistic elements, training of a language model may be ill-affected.

Non-linguistic elements of raw dark web data may include elements from which meaning is extractable. Since these elements appear frequently and may be of high importance, it may be inappropriate to simply exclude the elements from the training of a language model. Therefore, according to the exemplary embodiment of the present disclosure, non-linguistic elements of raw dark web data may be classified as completely non-linguistic elements (e.g., a hash value) that are any strings with no linguistic meaning, and non-linguistic elements (e.g., a uniform resource locator (URL)) from which linguistic meanings may be inferred.

Consequently, raw dark web data may include non-linguistic elements, and non-linguistic elements of which linguistic meaning is inferable among the non-linguistic elements may be included among targets of masking.

The device 100 for performing a task for cybersecurity on the basis of the dark web may evaluate the BERT-based language model.

In connection with a ransomware leak site detection task, Table 1 below shows performance comparison results between a BERT-based language model DarkBERTraw according to an exemplary embodiment of the present disclosure and other BERT-based language models.

TABLE 1

| Input | Model | Precision | Recall | F1 score |
|---|---|---|---|---|
| Raw | BERT_{cased} | 75.83 | 69.52 | 71.01 |
| | BERT_{uncased} | 77.18 | 73.90 | 72.77 |
| | RoBERTa | 39.83 | 36.00 | 36.27 |
| | DarkBERT_{raw} | 78.81 | 83.62 | 79.98 |
| Preprocessed | BERT_{cased} | 76.81 | 68.19 | 70.13 |
| | BERT_{uncased} | 71.97 | 71.62 | 70.77 |
| | RoBERTa | 48.36 | 45.14 | 44.31 |
| | DarkBERT_{raw} | 85.16 | 84.57 | 84.11 |

Referring to Table 1, “Raw” represents the case where raw dark web data is input, and “Preprocessed” represents the case where preprocessed data, that is, data for pretraining, is input. It is possible to see that the BERT-based language model according to the exemplary embodiment of the present disclosure detects ransomware leak sites better than the other models.

In connection with a threat thread detection task, Table 2 below shows performance comparison results between the BERT-based language model DarkBERTraw according to the exemplary embodiment of the present disclosure and other BERT-based language models.

TABLE 2

| Input | Model | Precision | Recall | F1 score |
|---|---|---|---|---|
| Raw | BERT_{cased} | 55.09 | 19.91 | 26.90 |
| | BERT_{uncased} | 52.34 | 23.49 | 28.51 |
| | RoBERTa | 28.97 | 17.89 | 21.38 |
| | DarkBERT_{raw} | 75.93 | 43.08 | 52.85 |
| Preprocessed | BERT_{cased} | 61.43 | 20.48 | 28.81 |
| | BERT_{uncased} | 45.46 | 21.52 | 26.16 |
| | RoBERTa | 29.04 | 15.27 | 18.71 |
| | DarkBERT_{raw} | 72.44 | 45.13 | 54.17 |

Referring to Table 2, “Raw” represents the case where raw dark web data is input, and “Preprocessed” represents the case where preprocessed data, that is, data for pretraining, is input. It is possible to see that the BERT-based language model according to the exemplary embodiment of the present disclosure detects threat threads better than the other models.

Meanwhile, self-supervised learning of a language model is a technology for a model to learn given data on its own. This method may be particularly used for pretraining a model by utilizing a large amount of data without labels. Self-supervised learning is a method for a model to improve comprehension using information or patterns inherent in a corpus, and may often be performed by recovering the original text from a variant of given text.

More specifically, self-supervised learning may be performed to aid a model in comprehending context, grammar, meanings, and the like in data. For example, a specific word in text is masked, and a masking language model (MLM) predicts the masked word on the basis of the context. As another example, next sentence prediction (NSP) is a task in which, when two sentences are given, a model predicts a possibility that the second sentence will follow the first sentence, which may aid in contextualization. Further, in a language modeling task, a model is trained to predict a word at a specific position, and the context may be grasped by referring to previous words and predicting the next word.

Subsequently, the language model may generate unlabeled data on the basis of a set self-supervised learning task. For example, collected documents may be tokenized, some tokens may be masked, and then an MLM may be trained to predict words of the masked tokens.

TABLE 3

| | |
|---|---|
| Original | The Dropper drops a zipped |
| text: | SysJoker(53f1bb23f670d331c9041748e7e8e396) |
| Question: | The Dropper [MASK] a zipped SysJoker |
| | (53f1bb23f670d331c9041748e7e8e396) |

Referring to Table 3, when the original text is “The Dropper drops a zipped SysJoker (53f1bb23f670d331c9041748e7e8e396)” and the question is “The Dropper [MASK] a zipped SysJoker (53f1bb23f670d331c9041748e7e8e396),” the ML learns that the word “drops” fits in the [MASK] part on the basis of the context.

Here, cybersecurity documents include more non-linguistic elements than other documents. The non-linguistic elements may include information unrelated to language, that is, information unrelated to the structure, grammar, and meanings of context and information unsuited to the training objective of the model.

Since non-linguistic elements are complicated, arbitrary, and often meaningless strings of characters, self-supervised learning applied thereto is ineffective. When self-supervised learning is performed without considering these non-linguistic elements, training of a language model may be ill-affected.

TABLE 4

| | |
|---|---|
| Original | The Dropper drops a zipped |
| text: | SysJoker(53f1bb23f670d331c9041748e7e8e396) |
| Question: | The Dropper a zipped SysJoker |
| | (53f1bb23f670[MASK]31c9041748e7e8e396) |

In Table 4, “53f1bb23f670d331c9041748e7e8e396” is a message digest (MD5) hash value, which is an arbitrary string. Accordingly, no linguistic meaning is obtained by reading the MD5 hash value. Therefore, in the training of the MLM, even when “[MASK]” is in the MD5 string, there is no linguistic reason for “d3” to fit in.

Meanwhile, non-linguistic elements of cybersecurity documents may include elements from which meaning is extractable. Since these elements appear frequently and may be of high importance, it may be inappropriate to simply exclude the elements from the training of a language model. Therefore, according to the exemplary embodiment of the present disclosure, non-linguistic elements of cybersecurity documents may be classified as completely non-linguistic elements that are any strings with no linguistic meaning, and paralinguistic elements from which linguistic meanings may be inferred.

TABLE 5

Example: The Dropper drops a zipped SysJoker
(53f1bb23f670d331c9041748e7e8e396)
from C2 https[://]github[.]url-mini[.] com/msg.zip, copies it to...

In Table 5, “53f1bb23f670d331c9041748e7e8e396” is an MD5 hash value which is a non-linguistic element. “53f1bb23f670d331c9041748e7e8e396” is an arbitrary string and thus provides no linguistic meaning in the document. On the other hand, “https[://] github [.] url-mini [.] com/msg.zip” in Table 5 is a URL which is a non-linguistic element, but the URL impersonates a Github website and includes linguistic content that may be inferred to direct people to download a file named “msg.zip.” Completely excluding these elements from the training of a language model may not aid the language model in comprehending the overall context of a cybersecurity document.

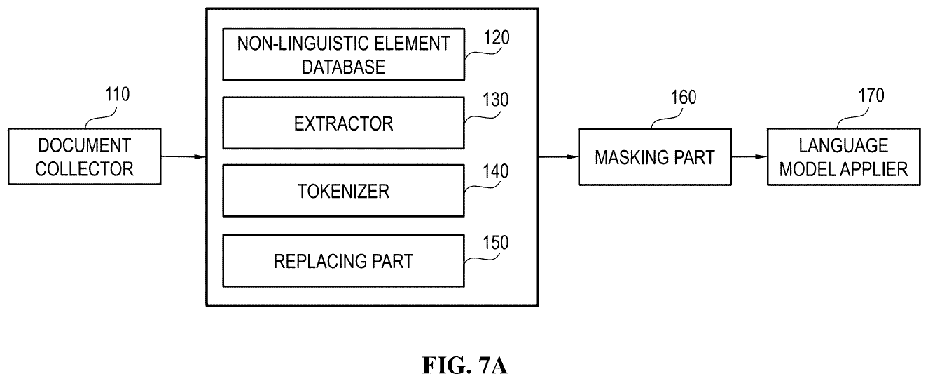

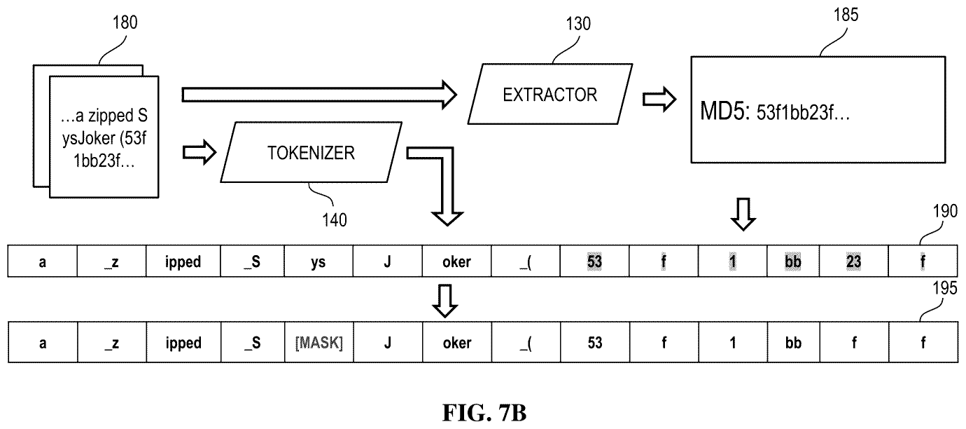

A process of training a language model for cybersecurity according to an exemplary embodiment of the present disclosure will be described below with reference to FIGS. 7A to 13.

FIG. 7A is a configuration diagram illustrating a system for training a language model for cybersecurity according to an exemplary embodiment of the present disclosure.

Referring to FIG. 7A, the system for training a language model for cybersecurity according to the exemplary embodiment of the present disclosure includes a document collector 110, a non-linguistic element database 120, an extractor 130, a tokenizer 140, a replacing part 150, a masking part 160, and a language model applier 170.

The document collector 110 may collect documents used for training a language model for cybersecurity. The documents are preferably related to cybersecurity. Multiple strings constituting the documents may include linguistic elements and non-linguistic elements.

The non-linguistic elements appearing in the cybersecurity documents may include 26- to 35-character bitcoin addresses, different types of hashes (e.g., a secure hash algorithm (SHA) hash value of a 64-character file and an MD5 hash value of a 32-character file), Internet protocol (IP) addresses, vulnerability identifiers, and the like. For example, “53f1bb23f670d331c9041748e7e8e396” is an arbitrary string which is an MD5 hash value with no linguistic meaning and thus may be classified as a non-linguistic element.

Further, other non-linguistic elements appearing in the cybersecurity documents may include website addresses, email addresses, and the like. URLs, email addresses, and the like may be distinguished from non-linguistic elements such as hash values and the like. URLs and email addresses may be composed of any string, but their strings may be used to determine whether a malicious user impersonates a specific website or directs people to download a specific malicious file through the URL. In the present disclosure, these are defined as paralinguistic elements. Paralinguistic elements are distinguishable from completely non-linguistic elements but are included among non-linguistic elements.

The non-linguistic element database 120 may include data about non-linguistic elements appearing in the cybersecurity documents and identification code data in which the non-linguistic elements are categorized.

As an example, “53f1bb23f670d331c9041748e7e8e396” in the string “The Dropper drops a zipped SysJoker (53f1bb23f670d331c9041748e7e8e396) from C2 http[://] github[.] url-mini[.] com/msg.zip, copies it to” is a first non-linguistic element which is a completely non-linguistic element, classified as an MD5 hash, and may be stored in the non-linguistic element database 120 together with an MD5 identification code.

As another example, “http[://] github [.] url-mini [.] com/msg.zip” is a second non-linguistic element which is a paralinguistic element among non-linguistic elements, classified as a URL, and may be stored in the non-linguistic element database 120 together with a URL identification code.

The extractor 130 may function to extract strings corresponding to non-linguistic elements, that is, first non-linguistic elements and/or second non-linguistic elements, among the multiple strings constituting the documents collected by the document collector 110 and record the extracted strings in the non-linguistic element database 120. Further, the extractor 130 may extract non-linguistic elements from the documents and mark tokens corresponding to the non-linguistic elements among tokens generated by the tokenizer 140.

The tokenizer 140 divides text of the cybersecurity documents into smaller units and tokenizes the units. The tokens may correspond to sentences, words, or other linguistically meaningful parts, and these are intended to appropriately supply text data to the language model. The tokenizer 140 may generate tokens for a text sequence, and the extractor 130 may mark tokens corresponding to the non-linguistic elements.

The replacing part 150 may function to replace the non-linguistic elements in the cybersecurity documents with arbitrary strings. Here, the strings may be changed in accordance with non-linguistic identification codes corresponding to the non-linguistic elements. In this case, the tokenizer 140 may tokenize the documents of which the non-linguistic elements have been replaced with the strings.

The replacing part 150 according to the exemplary embodiment of the present disclosure may only replace completely non-linguistic elements with an identification code among non-linguistic elements included in the cybersecurity documents. For example, when a text sequence of the cybersecurity documents is “The Dropper drops a zipped SysJoker (53f1bb23f670d331c9041748e7e8e396),” “53f1bb23f670d331c9041748e7e8e396” is an MD5 hash value which corresponds to a completely non-linguistic element. The replacing part 150 may replace “53f1bb23f670d331c9041748e7e8e396” with a preset identification code. Here, the replacing part 150 may not replace paralinguistic elements such as a URL and the like.

The replacing part 150 according to another exemplary embodiment of the present disclosure may replace all non-linguistic elements including paralinguistic elements with identification codes among the non-linguistic elements included in the cybersecurity documents. For example, when a text sequence of the cybersecurity documents is “Get the sample from the website <www.google.com>. Then the sample will be processed,” “www.google.com” is a URL which is a non-linguistic element, but corresponds to a paralinguistic element which is distinguished from completely non-linguistic elements such as MD5 hash values. According to the present embodiment, the replacing part 150 may replace not only completely non-linguistic elements but also paralinguistic elements with preset identification codes. In other words, “www.google.com” in the above example may be replaced.

Alternatively, according to an embodiment, the replacing part 150 may not function. In other words, the replacing part 150 may not process non-linguistic elements of the cybersecurity documents.

The masking part 160 randomly masks a token. The masked token is a target for the model to predict. This is intended to aid the model in grasping the context and making a prediction.

The masking part 160 according to the exemplary embodiment of the present disclosure may only mask a specific ratio of tokens corresponding to linguistic elements. In other words, the masking part 160 may mask tokens other than those corresponding to non-linguistic elements.

The masking part 160 according to another exemplary embodiment of the present disclosure may mask tokens corresponding to paralinguistic elements among the non-linguistic elements. In other words, the masking part 160 may mask tokens corresponding to linguistic elements and paralinguistic elements rather than tokens corresponding to completely non-linguistic elements.

The language model applier 170 may provide tokens for text sequences, including masked tokens, as inputs for the pretrained general-use language model.

Subsequently, the model may be trained to predict a token at a masked position and categorize the token simultaneously. In other words, according to the exemplary embodiment of the present disclosure, a model to be trained may be trained to perform two tasks simultaneously on a single input, first, to predict the original token, and second, to predict the type of token.

More specifically, since the masking part 160 according to the exemplary embodiment of the present disclosure may only mask tokens corresponding to linguistic elements rather than non-linguistic elements, the language model to be trained may be trained to recover only linguistic elements of a document. In other words, in the system according to the exemplary embodiment of the present disclosure, a language model learns only sequences of cybersecurity documents from which non-linguistic elements are excluded, and thus it is possible to improve performance in identifying interactions and/or semantic similarities between linguistic elements included in cybersecurity documents. Further, performance in comprehending the context of cybersecurity documents and/or performance in identifying connections between cybersecurity documents and key points of cybersecurity documents can be improved compared to the case of learning entire sequences including non-linguistic elements.

Moreover, the language model according to the exemplary embodiment of the present disclosure may be trained to categorize tokens for an input text sequence.

According to the exemplary embodiment of the present disclosure, the language model to be trained may predict a type of token by referring to data about non-linguistic elements of the non-linguistic element database 120 and identification code data in which the non-linguistic elements are categorized. In other words, in the system according to the exemplary embodiment of the present disclosure, the language model may be trained to categorize non-linguistic elements of a cybersecurity document.

Although not shown in the drawings, the system for training a language model for cybersecurity according to the exemplary embodiment of the present disclosure may include a transceiver, a memory, and a processor.

The transceiver may communicate with any external device or server. As an example, the system may receive a document related to cybersecurity from an external server through the transceiver. As another example, the system for training a language model for cybersecurity may transmit a prediction result of the language model to any external device or server through the transceiver.

The system may access a network through the transceiver to transmit and receive various data. Types of transceivers may largely include a wired type of transceiver and a wireless type of transceiver. Since the wired type and the wireless type have their own strengths and weaknesses, the wired type of transceiver and the wireless type of transceiver may be simultaneously provided in the system for training a language model for cybersecurity in some cases. Here, the wireless type of transceiver may mainly employ a wireless local area network (WLAN)-based communication method such as Wi-Fi. Alternatively, the wireless type of transceiver may employ cellular communication, for example, a Long Term Evolution (LTE) or fifth generation (5G)-based communication method. However, wireless communication protocols are not limited to the foregoing examples, and any appropriate wireless communication method can be used. Representative examples of the wired communication method are LAN and Universal Serial Bus (USB) communication, and other methods can also be used.

The memory may store various information. Various data may be temporarily or semi-permanently stored in the memory. Examples of the memory may include a hard disk drive (HDD), a solid state drive (SSD), a flash memory, a read-only memory (ROM), a random access memory (RAM), and the like. The memory may be provided in a form that is embedded in the system or detachable from the system. The memory may store various data required for operating the system such as an operating system (OS) for running the system and a program for operating each component of the system.

The processor may control the overall operations of the system. Specifically, the processor may load and execute a program for the overall operations of the system from the memory. The processor may be implemented as an application processor (AP), a CPU, a microcontroller unit (MCU), or a similar device thereto in accordance with hardware, software, or a combination thereof. In terms of hardware, the processor may be provided in the form of an electronic circuit for processing an electrical signal to perform a control function, and in terms of software, may be provided in the form of a program or code for operating hardware circuitry.

FIG. 7B is a diagram illustrating a process of generating input data for a language model in the system for training a language model for cybersecurity according to the exemplary embodiment of the present disclosure.

In the example of FIG. 7B, a cybersecurity document 180 to be used for training a language model may be collected. Here, a plurality of strings constituting the document include linguistic elements and non-linguistic elements.

The tokenizer 140 generates tokens by dividing text of the cybersecurity document into smaller units as indicated by a reference numeral 190. Here, tokens corresponding to non-linguistic elements 185 may be replaced with a preset identification code by the extractor 130.

Subsequently, the masking part 160 may randomly masks tokens to generate masking tokens as indicated by a reference numeral 195. Here, the masking part 160 according to the exemplary embodiment of the present disclosure may mask tokens other than those corresponding to non-linguistic elements. In the example of FIG. 7B, the reference numeral 195 may show input data for the language model to be trained.

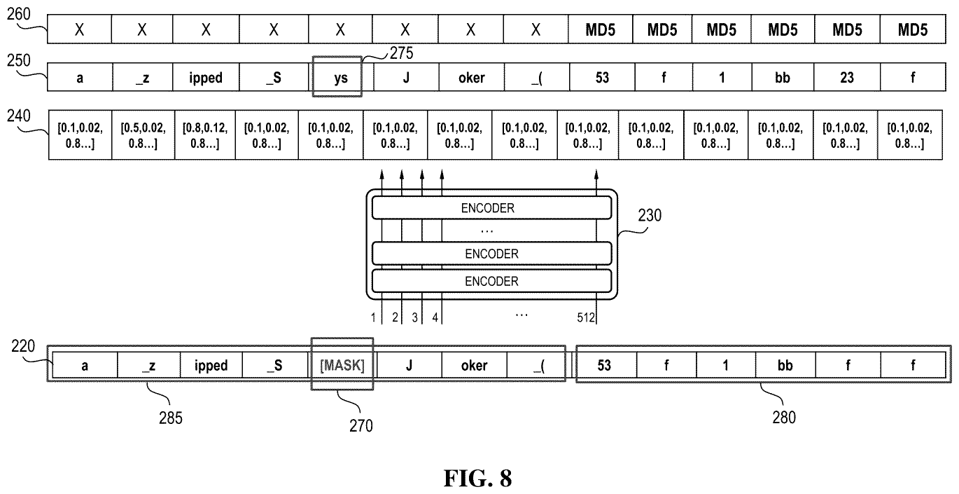

FIG. 8 is an exemplary diagram illustrating a process of training a language model for cybersecurity according to an exemplary embodiment of the present disclosure.

In the example of FIG. 8, a text sequence 220 may be input to a language model 230 in the form of masking tokens. As described above with reference to FIG. 7B, data input to the language model 230 may be a text sequence of which only a token 270 among tokens 285 corresponding to linguistic elements rather than tokens 280 corresponding to a non-linguistic element is randomly masked.

The language model 230 may generate vectors 240 by extracting features of the input data. In general, the language model 230 may divide text data into words or n-grams (groups of consecutive words) to express text data using numerals and may map each word or n-gram to a numeric vector. For such a vector expression, technology such as word embedding or term frequency-inverse document frequency (TF-IDF) may be used, and the present disclosure is not limited by a vector expression method.

Subsequently, the language model 230 may be trained to simultaneously predict the token at the masked position and categorize tokens included in the text sequence 220.

In other words, according to the exemplary embodiment of the present disclosure, a model to be trained may be trained to perform two tasks simultaneously on the single input 220, first, to output a result 250 by predicting the original token, and second, to output a result 260 by predicting the type of token.

More specifically, the language model 230 may be trained to predict the token 270 at the masked position in the input data as indicated by a reference numeral 275. Here, the model may be updated using a loss function to minimize the difference between the prediction and an actual value.

Further, the language model 230 may be trained to classify the entire text sequence 220 including the tokens 280 corresponding to the non-linguistic elements, as indicated by a reference numeral 260. In the example of FIG. 8, the language model 230 classifies the tokens 280 corresponding to the non-linguistic elements in the input data as “MD5” and classifies the tokens corresponding to the linguistic elements 285 as “F” or “no classification value,” that is, “X.” Here, the language model 230 may predict the types of tokens by referring to data about non-linguistic elements of the non-linguistic element database 120 and identification code data in which the non-linguistic elements are categorized.

In the system according to the exemplary embodiment of the present disclosure, the language model 230 is trained using text sequences, of which some linguistic elements are masked, in cybersecurity documents from which non-linguistic elements are excluded. Accordingly, it is possible to improve performance in identifying interactions and/or semantic similarities between linguistic elements included in cybersecurity documents. Further, performance in comprehending the context of cybersecurity documents and/or performance in identifying connections between cybersecurity documents and key points of cybersecurity documents can be improved compared to the case of learning entire text sequences including non-linguistic elements.

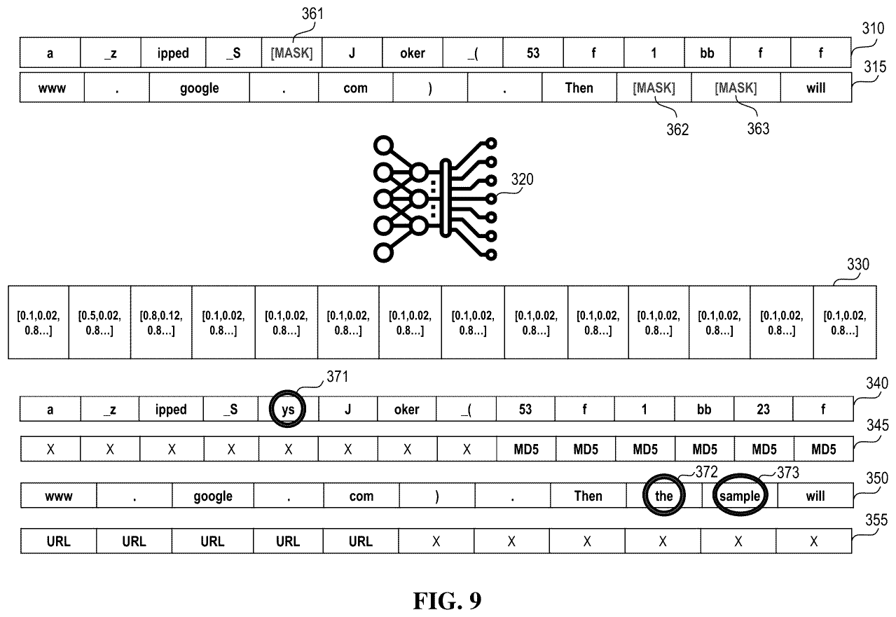

FIGS. 9 to 13 are exemplary diagrams illustrating a process of training a language model for cybersecurity according to an exemplary embodiment of the present disclosure.

FIG. 9 is an exemplary diagram illustrating a process of training a language model by inputting a cybersecurity document with only tokens for linguistic elements masked into the language model.

In the example of FIG. 9, the cybersecurity document may be input into a language model 320 with only tokens for linguistic elements masked rather than tokens for non-linguistic elements (MD5 hash values in an example 310, and a URL in an example 315) as indicated by reference numerals 310 and 315.

Subsequently, the language model 320 may generate vectors 330 by extracting features of the input data.

Subsequently, the language model 320 may be trained to simultaneously predict the tokens at the masked positions in the input sequences and categorize the tokens included in the input sequences on the basis of the input data vectors 330.

More specifically, the language model 320 may be trained to predict tokens 361, 362, and 363 at the masked positions in the input data as indicated by reference numerals 371, 372, and 373. Here, the language model 320 may be updated using a loss function to minimize the difference between the predicted values and actual values.

Further, the language model 320 may be trained to classify the entire input sequences including non-linguistic elements in the input data as indicated by reference numerals 345 and 355. In the example of FIG. 9, the language model 320 may classify non-linguistic elements (i.e. completely non-linguistic elements) in the output 345 for the first input data 310 as “MD5” and classify linguistic elements as “no classification value,” that is, “X.” The language model 320 may classify non-linguistic elements (i.e. paralinguistic elements) in the output 355 for the second input data 315 as “URL” and classify linguistic elements as “no classification value,” that is, “X.” Here, the language model 320 may predict the types of tokens by referring to data about non-linguistic elements of the non-linguistic element database 120 and identification code data in which the non-linguistic elements are categorized.

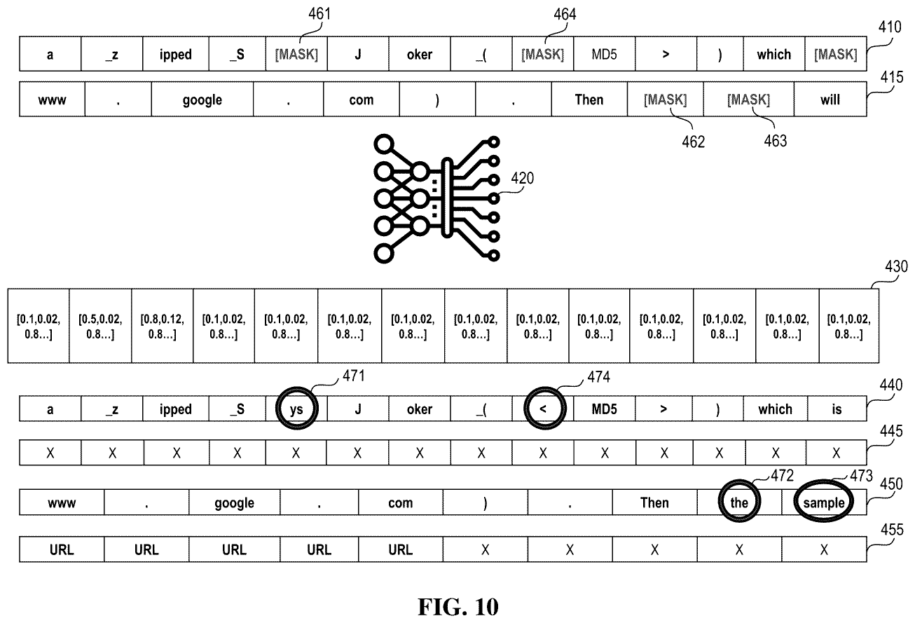

FIG. 10 is an exemplary diagram illustrating a process of replacing completely non-linguistic elements in a cybersecurity document with identification codes, tokenizing the cybersecurity document, and then inputting the cybersecurity document with only tokens for linguistic elements masked into a language model to train the language model.

In the example of FIG. 10, the cybersecurity document in which completely non-linguistic elements are replaced with identification codes and only tokens for linguistic elements are masked may be input.

As an example, when a text sequence of the cybersecurity document is “The Dropper drops a zipped SysJoker (53f1bb23f670d331c9041748e7e8e396),” “53f1bb23f670d331c9041748e7e8e396” is an MD5 hash value which corresponds to a completely non-linguistic element. According to the present embodiment, completely non-linguistic elements may be replaced with a preset identification code and tokenized. Since only linguistic elements are left in the text sequence of which non-linguistic elements are replaced with the identification code, all the tokens are randomly masked, and data 410 may be input into a language model 420.

As another example, when a text sequence of the cybersecurity document is “Get the sample from the website <www.google.com>. Then the sample will be processed,” “www.google.com” is a URL which is a non-linguistic element, but corresponds to a paralinguistic element which is distinguished from completely non-linguistic elements such as MD5 hash values. According to the present embodiment, only completely non-linguistic elements are replaced with the identification code, and paralinguistic elements may not be replaced but tokenized. In other words, “www.google.com” in the above example is not replaced, and the entire text sequence is tokenized. Subsequently, only tokens corresponding to linguistic elements, that is, tokens other than those corresponding to “www.google.com,” are randomly masked, and data 415 may be input into the language model 420.

Subsequently, the language model 420 may generate vectors 430 by extracting features of the input data.

Subsequently, the language model 420 may be trained to simultaneously predict the tokens at the masked positions in the input sequences and categorize the tokens included in the input sequences on the basis of the input data vectors 430.

More specifically, the language model 420 may be trained to predict tokens 461, 462, 463, and 464 at the masked positions in the input data as indicated by reference numerals 471, 472, 473, and 474. Here, the language model 420 may be updated using a loss function to minimize the difference between the predicted values and actual values.

Further, the language model 420 may be trained to classify the entire input sequences including non-linguistic elements in the input data as indicated by reference numerals 445 and 455. Here, the language model 420 may predict the types of tokens by referring to data about non-linguistic elements of the non-linguistic element database 120 and identification code data in which the non-linguistic elements are categorized.

In the example of FIG. 10, non-linguistic elements of the input data 410 are replaced with the identification code “MD5,” and only linguistic elements are left. Since the language model 420 according to the exemplary embodiment of the present disclosure classifies linguistic elements as “no classification value,” all the tokens may be classified as “no classification value,” that is, “X,” as indicated by a reference numeral 445. Further, with regard to the input data 415, the language model 420 may classify non-linguistic elements (i.e. paralinguistic elements) as “URL” and classify linguistic elements as “no classification value,” that is, “X,” thereby outputting data 455.

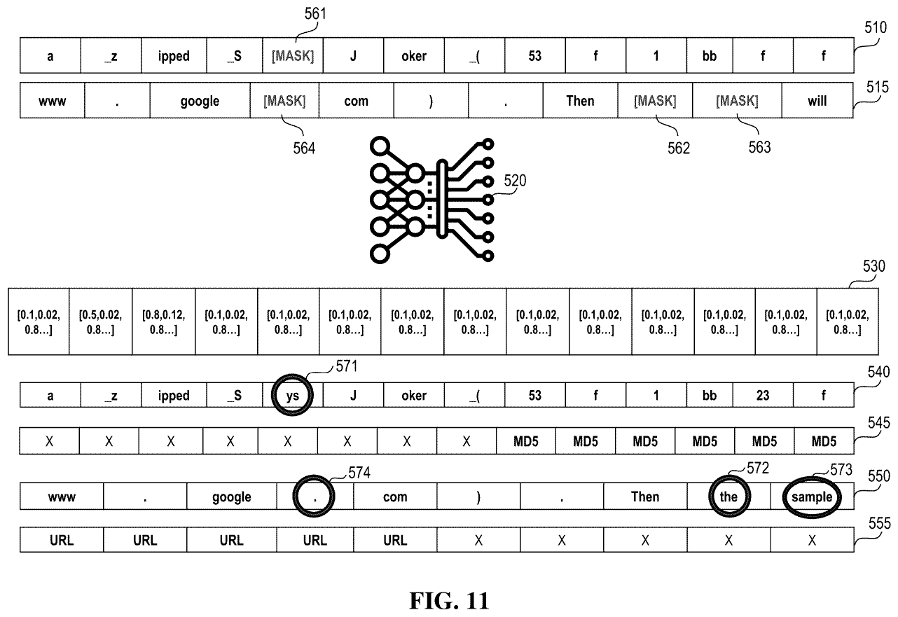

FIG. 11 is an exemplary diagram illustrating a process of inputting a cybersecurity document with tokens for linguistic elements masked and tokens for paralinguistic element masked into a language model to train the language model.

In the example of FIG. 11, the cybersecurity document is tokenized without replacement, and the cybersecurity document in which tokens for paralinguistic elements and linguistic elements rather than tokens for completely non-linguistic elements are masked may be input into a language model 520. For example, tokens of input data 510 may be randomly masked except for MD5 hash values which are completely non-linguistic elements, tokens of input data 515 including a URL which is a paralinguistic element may be randomly masked, and the tokens may be input to the language model 520.

Subsequently, the language model 520 may generate vectors 530 by extracting features of the input data.

Subsequently, the language model 520 may be trained to simultaneously predict the tokens at the masked positions in the input sequences and categorize the tokens included in the input sequences on the basis of the input data vectors 530.

More specifically, the language model 520 may be trained to predict tokens 561, 562, and 563 at the masked positions in the input data as indicated by reference numerals 571, 572, and 573. In addition, a token 564 is a masking token for a paralinguistic element, and the language model 520 may predict the masking token 564 as indicated by a reference numeral 574. Here, the language model 520 may be updated using a loss function to minimize the difference between the predicted values and actual values.

In particular, according to the above embodiment, the language model 520 learns linguistic elements and paralinguistic elements of which meanings may be inferred, rather than completely non-linguistic elements, from cybersecurity documents. Accordingly, it is possible to improve performance in identifying interactions between linguistic elements and paralinguistic elements of which meanings may be inferred, and inferring the overall context of cybersecurity documents.

Further, the language model 520 may be trained to classify the entire input sequences including non-linguistic elements in the input data as indicated by reference numerals 545 and 555. In the example of FIG. 11, the language model 520 may classify non-linguistic elements (i.e. completely non-linguistic elements) of the output 545 for the first input data 510 as “MD5” and classify linguistic elements as “no classification value,” that is, “X.” The language model 520 may classify non-linguistic elements (i.e. paralinguistic elements) of the output 555 for the second input data 515 as “URL” and classify linguistic elements as “no classification value,” that is, “X.” Here, the language model 520 may predict the types of tokens by referring to data about non-linguistic elements of the non-linguistic element database 120 and identification code data in which the non-linguistic elements are categorized.

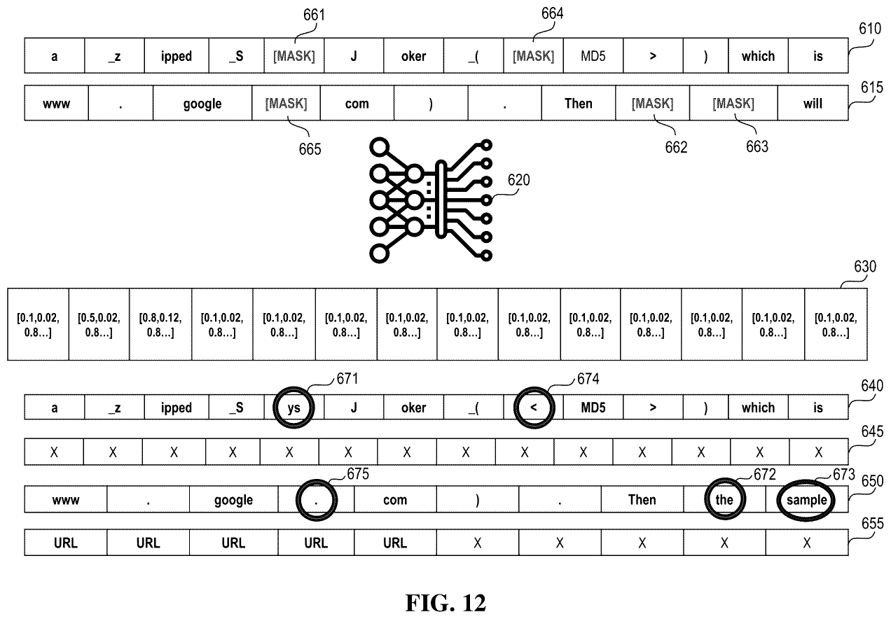

FIG. 12 is an exemplary diagram illustrating a process of replacing completely non-linguistic elements in a cybersecurity document with identification codes, tokenizing the cybersecurity document, and then inputting the cybersecurity document with all the tokens masked into a language model to train the language model.

In the example of FIG. 12, the cybersecurity document in which completely non-linguistic elements are replaced with identification codes and all the tokens are randomly masked may be input into a language model 620.

As an example, when a text sequence of the cybersecurity document is “The Dropper drops a zipped SysJoker (53f1bb23f670d331c9041748e7e8e396),” “53f1bb23f670d331c9041748e7e8e396” is an MD5 hash value which corresponds to a completely non-linguistic element. According to the present embodiment, completely non-linguistic elements may be replaced with a preset identification code and tokenized. Subsequently, all the tokens are randomly masked, and data 610 may be input into a language model 620.

As another example, when a text sequence of the cybersecurity document is “Get the sample from the website <www.google.com>. Then the sample will be processed,” “www.google.com” is a URL which is a non-linguistic element, but corresponds to a paralinguistic element which is distinguished from completely non-linguistic elements such as MD5 hash values. According to the present embodiment, only completely non-linguistic elements are replaced with the identification code, and paralinguistic elements may not be replaced but tokenized. In other words, “www.google.com” in the above example is not replaced, and the entire text sequence may be tokenized. Subsequently, all the tokens are randomly masked, and data 615 may be input into the language model 620.

Subsequently, the language model 620 may generate vectors 630 by extracting features of the input data.

Subsequently, the language model 620 may be trained to simultaneously predict the tokens at the masked positions in the input sequences and categorize the tokens included in the input sequences on the basis of the input data vectors 630.

More specifically, the language model 620 may be trained to predict tokens 661, 662, 663, and 664 at the masked positions in the input data as indicated by reference numerals 671, 672, 673, and 674. Further, a token 664 is a masking token for a paralinguistic element, and the language model 620 may predict the masking token 664 as indicated by a reference numeral 674. Here, the language model 620 may be updated using a loss function to minimize the difference between the predicted values and actual values.

Further, the language model 620 may be trained to classify the entire input sequences including non-linguistic elements in the input data as indicated by reference numerals 645 and 655. Here, the language model 620 may predict the types of tokens by referring to data about non-linguistic elements of the non-linguistic element database 120 and identification code data in which the non-linguistic elements are categorized.

In the example of FIG. 12, non-linguistic elements (i.e. completely non-linguistic elements) of the input data 610 are replaced with the identification code “MD5,” and only linguistic elements are left. Since the language model 620 according to the exemplary embodiment of the present disclosure classifies linguistic elements as “no classification value,” all the tokens may be classified as “no classification value,” that is, “X,” as indicated by a reference numeral 645. Further, with regard to the input data 615, the language model 620 may classify non-linguistic elements (i.e. paralinguistic element) as “URL” and classify linguistic elements as “no classification value,” that is, “X,” thereby outputting data 655.

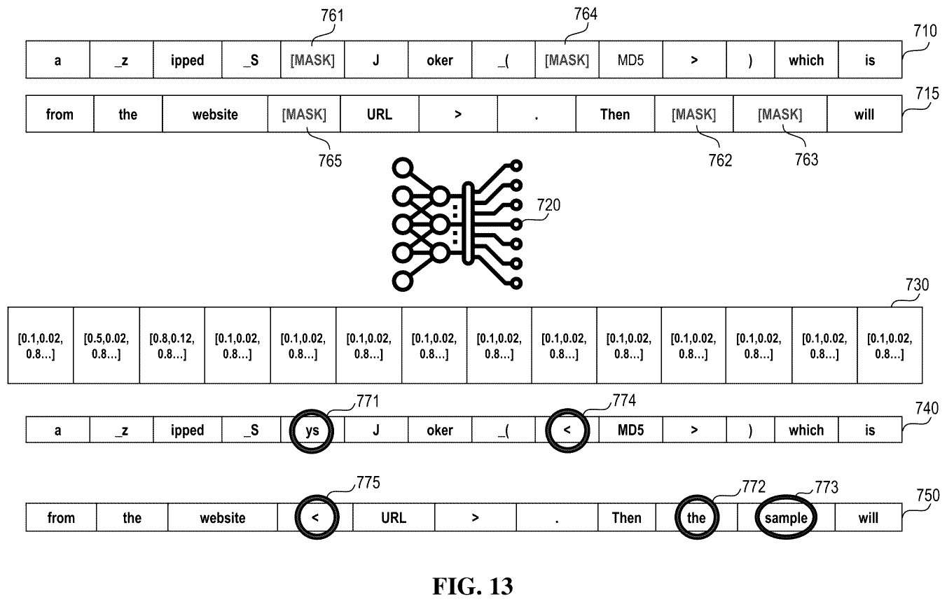

FIG. 13 is an exemplary diagram illustrating a process of replacing non-linguistic elements in a cybersecurity document with identification codes, tokenizing the cybersecurity document, and then inputting the cybersecurity document with all the tokens masked into a language model to train the language model.

In the example of FIG. 13, the cybersecurity document in which non-linguistic elements (i.e. completely non-linguistic elements and paralinguistic element) are replaced with identification codes and all the tokens are randomly masked may be input into a language model 720.

As an example, when a text sequence of the cybersecurity document is “The Dropper drops a zipped SysJoker (53f1bb23f670d331c9041748e7e8e396),” “53f1bb23f670d331c9041748e7e8e396” is an MD5 hash value which corresponds to a non-linguistic element. According to the present embodiment, non-linguistic elements may be replaced with a preset identification code and tokenized. Subsequently, all the tokens are randomly masked, and data 710 may be input into a language model 720.

As another example, when a text sequence of the cybersecurity document is “Get the sample from the website <www.google.com>. Then the sample will be processed,” “www.google.com” is a URL which is a non-linguistic element, but corresponds to a paralinguistic element which is distinguished from completely non-linguistic elements such as MD5 hash values. According to the present embodiment, paralinguistic elements may also be replaced with a preset identification code and tokenized. Subsequently, all the tokens are randomly masked, and data 715 may be input into the language model 720.

Subsequently, the language model 720 may generate vectors 730 by extracting features of the input data.

Subsequently, the language model 720 may be trained to predict the tokens at the masked positions in the input sequences on the basis of the input data vectors 730. More specifically, the language model 720 may be trained to predict tokens 761 to 765 at the masked positions in the input data as indicated by reference numerals 771 to 775. Here, the language model 720 may be updated using a loss function to minimize the difference between the predicted values and actual values.

Meanwhile, in the above exemplary embodiment, all the non-linguistic elements are replaced with the preset identification code and then tokenized, and thus there are no non-linguistic elements in the input data. Therefore, it is unnecessary to additionally perform a token categorization task. This is because the language model 720 according to the exemplary embodiment of the present disclosure classifies linguistic elements as “no classification value.”

The device 100 for performing a task for cybersecurity on the basis of the dark web according to the exemplary embodiment may include a computer program stored in a computer-readable recording medium to perform the above-described operations S302 to S310 of FIG. 3 in combination with a computer (or computing device) which is hardware.

The device 100 for performing a task for cybersecurity on the basis of the dark web may be implemented as a computing device including at least one processor that executes instructions of programs loaded into a memory, and a program including instructions to perform the above-described operations S302 to S310 of FIG. 3 may be loaded into the memory.

According to exemplary embodiments of the present disclosure, a BERT-based language model can learn context specialized for the dark web by pretraining the BERT-based language model using preprocessed training data related to the dark web and then fine-tuning the BERT-based language model using labeled data, and it is possible to improve the performance of the BERT-based language model accordingly.

Further, according to exemplary embodiments of the present disclosure, it is possible to perform tasks for cybersecurity, such as detecting a ransomware leak site, detecting a threat thread, inferring a threat keyword, and the like, using a high-performance language model specialized for the dark web where a cybercrime ecosystem is formed and various illegal activities are conducted.

Effects of the present disclosure are not limited to those described above, and other effects which have not been described will be clearly understood by those skilled in the technical field to which the present invention pertains from the specification and accompanying drawings.

The above-described device may be implemented as a hardware component, a software component, and/or a combination of a hardware component and a software component. For example, the device and components described in the embodiments may be implemented using one or more general computing devices or specific-purpose computing devices such as processors, controllers, arithmetic logic units (ALUs), digital signal processors, microcomputers, FPGAs, programmable logic units (PLUS), microprocessors, or any other devices for executing instructions and responding thereto. The processing device may execute an OS and one or more software applications executed on the OS. In addition, the processing device may access, store, manipulate, process, and generate data in response to the execution of software. For convenience of understanding, it is described that a single processing device is used, but those of ordinary skill in the art may understand that the processing device may include a plurality of processing elements and/or a plurality of types of processing elements. For example, the processing device may include a plurality of processors or one processor and one controller. In addition, another processing configuration such as parallel processors is possible.

The software may include a computer program, code, instructions, or a combination of one or more thereof, and may configure a processing device to operate as desired or instruct processing devices independently or collectively. To be interpreted by the processing device or to provide instructions or data to the processing device, software and/or data may be embodied in any type of machine, component, physical device, virtual equipment, computer storage medium or device, or transmitted signal wave permanently or temporarily. The software may be distributed over computer systems connected via a network, and stored or executed in a distributed manner. The software and data may be stored in one or more computer-readable recording media.

The methods according to the embodiments may be implemented in the form of program instructions that may be executed by various computing units and recorded on a computer-readable recording medium. The computer-readable recording medium may include program instructions, data files, data structures, and the like solely or in combination. The program instructions recorded on the medium may be those specially designed and configured for the purposes of the embodiments or may be known and available to those skilled in computer software. Examples of the computer-readable recording medium include magnetic media such as a hard disk, a floppy disk, and magnetic tape, optical media such as a compact disc (CD)-ROM and a digital video disc (DVD), magneto-optical media such as a floptical disk, and hardware devices specially configured to store and exchange program instructions such as a ROM, a RAM, a flash memory, and the like. Examples of the program instructions include not only machine code such as those generated by a compiler, but also high-level language code that may be executed by a computer using an interpreter or the like. The foregoing hardware devices may be configured to operate as one or more software modules to perform operations of the embodiments, and vice versa.

Although the present disclosure has been described above with reference to the limited exemplary embodiments and drawings, various modifications and variations can be made from the above description by those of ordinary skill in the art. For example, even when the described techniques are performed in an order different from the method described above, and/or even when components of the described system, structure, device, circuit, and the like are coupled or combined in a form different from the way described above or replaced or substituted with other components or equivalents, an appropriate result can be achieved.

Therefore, other implementations, other embodiments, and equivalents to the claims fall within the scope of the following claims.

What is claimed is:

1. A method of performing a task for cybersecurity on the basis of a dark web which is performed by a device, the method comprising:
acquiring raw dark web data from a database;
acquiring first dark web data by preprocessing the raw dark web data;
pretraining a bidirectional encoder representations from transformers (BERT)-based language model using the first dark web data;
fine-tuning the pretrained BERT-based language model using second dark web data; and
performing a task for cybersecurity using the fine-tuned BERT-based language model.

2. The method of claim 1, wherein the acquiring of the first dark web data by preprocessing the raw dark web data comprises:
acquiring a dark web text dataset from the raw dark web data;
balancing the dark web text dataset on the basis of categories; and
removing duplicate data of the dark web text dataset using a text similarity algorithm.

3. The method of claim 1, wherein, when the task is ransomware leak site detection, the fine-tuning of the pretrained BERT-based language model using the second dark web data comprises:
collecting ransomware leak sites from the raw dark web data;
labeling the ransomware leak sites as the second dark web data; and
training the BERT-based language model using the second dark web data.

4. The method of claim 1, wherein, when the task is threat thread classification, the fine-tuning of the pretrained BERT-based language model using the second dark web data comprises:
collecting threat threads from the raw dark web data;
labeling the threat threads as the second dark web data; and
training the BERT-based language model using the second dark web data.

5. The method of claim 1, further comprising, when the task is threat keyword inference, masking one or more elements in the raw dark web data,
wherein the performing of the task for cybersecurity using the fine-tuned BERT-based language model comprises outputting a possibility value of at least one element corresponding to a masked position using the fine-tuned BERT-based language model.

6. The method of claim 5, wherein the raw dark web data includes nonlinguistic elements, and
some of the nonlinguistic elements from which linguistic meaning is inferable are included among targets of masking.

7. A device for performing a task for cybersecurity on the basis of a dark web, the device comprising:
a memory; and
at least one processor including a bidirectional encoder representations from transformers (BERT)-based language model,
wherein the processor acquires raw dark web data from a database, acquires first dark web data by preprocessing the raw dark web data, pretrains the BERT-based language model using the first dark web data, fine-tunes the pretrained BERT-based language model using second dark web data, and performs a task for cybersecurity using the fine-tuned BERT-based language model,

8. A non-transitory computer-readable recording medium on which a computer program executed by a computer which is hardware is recorded, wherein the computer program comprises:
acquiring raw dark web data from a database;
acquiring first dark web data by preprocessing the raw dark web data;
pretraining a bidirectional encoder representations from transformers (BERT)-based language model using the first dark web data;
fine-tuning the pretrained BERT-based language model using second dark web data; and
performing a task for cybersecurity using the fine-tuned BERT-based language model.
